(19) United States
(12) Patent Application Publication
(10) Pub. No.: US 2005/0200481 A1
(43) Pub. Date: Sep. 15, 2005

(54) Smart polymeric multilayer sensors

(76) Inventor: Morton L. Wallach, Groton, CT (US)

Correspondence Address: Markets, Patents & Alliances LLC, 30 Glen Terrace, Stamford, CT, 06906-1401, US

(21) Appl. No.: 11/056,023

(22) Filed: Feb. 11, 2005

Related U.S. Application Data
(60) Provisional application No. 60/543,953, filed on Feb. 12, 2004.
(60) Provisional application No. 60/599,141, filed on Aug. 5, 2004.

(51) Int. Cl. G08B 5/00; G08B 21/00

(52) U.S. Cl. 340/541; 340/573.1; 340/601; 340/691.1; 116/206; 436/172; 250/395

(57) ABSTRACT

Sensor suitable for submarine detection, swimmer detection, wind shear detection, missile detection and chemical warfare agent detection are in the form of multilayer polymer beads. The sensors have a change in detectable property, such as color, which occurs when said sensors are exposed to a particular stimulus such as an object or event to be detected. The change in property is thus detectible by an external monitor.

### CROSS-REFERENCE TO RELATED APPLICATION

This application claims the benefit of U.S. provisional patent application Ser. No. 60/543,953, filed Feb. 12, 2004, and entitled “Smart Polymeric Multilayer Sensors”. Said provisional application Ser. No. 60/543,953, is incorporated herein by reference.

This application further claims the benefit of U.S. provisional patent application Ser. No. 60/599,141, filed Aug. 5, 2004, and entitled “Surface Swimmer Detection Via Sensors”. Said provisional application Ser. No. 60/599,141, is incorporated herein by reference.

This application further incorporates by reference U.S. provisional patent application Ser. No. 60/455,142, filed Mar. 17, 2003, and entitled “Smart Polymeric Multilayer Sensors”.

### FIELD OF INVENTION

This invention is in the field of polymeric sensors for detection and tracking.

### BACKGROUND

An improved low cost method of detecting submarines, small surface craft, underwater and surface swimmers, missiles, chemical warfare agents and potentially hazadous contents of ship containers is needed.

### SUMMARY OF THE INVENTION

The Summary of the Invention is provided as a guide to understanding the invention. It does not necessarily describe the most generic embodiment of the invention or all species of the invention disclosed herein.

The present invention comprises sensors that are in the form of multilayer polymer micro beads or other shapes and are about nanometers to millimeters in diameter. Said multilayer beads have a change in detectable property, such as color, density, buoyancy, or acoustic reflectivity, which occurs when exposed to a particular triggering stimulus. The change in said property is detectible by an external monitor.

### BRIEF DESCRIPTION OF DRAWINGS

FIG. 1 is a cross section of a typical three-layer sensor bead.

FIG. 2 illustrates the use of a field of sensors in submarine detection.

FIG. 3 illustrates the use of a field of sensors in swimmer detection.

### DETAILED DESCRIPTION OF INVENTION

The following detailed description discloses various embodiments and features of the invention. These embodiments and features are meant to be exemplary and not limiting. The present invention comprises sensors that are in the form of multilayer beads.

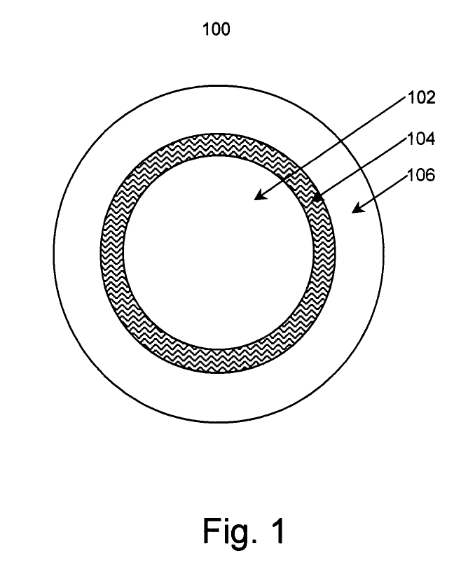

FIG. 1 illustrates the cross section of a typical sensor structure. Sensor 100 is generally spherical in shape. The sensor comprises a core 102, intermediate layer 104 and outer layer 106. Sensors may have an overall diameter in the range of a few nanometers to a few millimeters.

Sensors may also have nonspherical shapes, such as fabric swatches. Sensors may also be adhered to base film sheets.

Sensors may be distributed in large numbers in a given medium, such as air or water. When an object or chemical or physical effect disturbs said sensors, said sensors react and become detectible by a monitor. Hence the presence of said object, chemical or other physical effect may be detected.

Sensors are typically made from polymers. Suitable polymers depend upon the application. Suitable polymers include consumer, specialty, engineering, or high performance resins. Examples of suitable polymers include polyethylene, polypropylene, acrylics, vinyls, polyphenylene ether, and polyphenylene sulfide.

Biodegradable polymers such as poly(lactic acid) and aliphatic polyesters may also be used. Biodegradable polymers may be used so that sensors do not foul an ecosystem. Biodegradability can be from days to months depending on the microbe content of the medium that said sensors are distributed in.

Sensors may comprise metals. Said metals can be Fe, Cd, Se, Al, or Cu, mixtures thereof or other metals depending on the application. Metals can be employed as alloys, compounds, or in layered combination with polymers.

Sensors are typically core/shell in their morphological structure. They can also be other shapes or multilayer films. A shell can be coated onto a core. Alternatively, a core/shell can be polymerized as a core/shell structure.

Sensors may be made by known means for producing multilayer coatings. These known methods include the methods described in the Kirk-Othmer Encyclopedia of Chemical Technology, 4^{th} Edition, New York: Wiley, 1993, volume 6, pages 606 to 669. Said pages are incorporated herein by reference.

The core or intermediate layer of a sensor may exhibit luminescence, color change, change in acoustic reflectivity, electrical properties or other remotely detectible change in response to a specific triggering stimulus. The choice of which layer will be designed and formulated to respond to a given trigger is made depending on the application.

Depending on the application the outer layer can be a protective layer, reactive layer or shedding layer.

Sensors may be designed to be neutrally buoyant when distributed in a given fluid.

Sensors may comprise 1, 2, 3 or more layers wherein the core is considered to be a layer. The number of layers may depend upon the application. Table 1 presents a number of applications of said sensors. Column 1 lists what is detected. Column 2 lists the number of layers in a sensor. Column 3 lists the information provided by the sensors.

TABLE 1
Sensor Applications

| | | Information provided |
|---|---|---|
| Application | Layers in sensors | by sensor detection |
| Submarine | 2 or 3 | Detection of submarine |
| | | Tracking of submarine |
| Swimmer | 2 or 3 | Detection of swimmer |
| | | Increased acoustic range |
| Missile | 1 or 2 | Detection of missile |
| | | Tracking of missile |
| Wind Shear | 2 or 3 | Wind Intensity |
| | | Wind direction |
| Battlefield | 2 or 3 | Chemical agent |
| | | Biological agent |
| | | Dirty bomb |
| Shipping Container | 2 or 3 | Chemical agent |
| | | Biological agent |
| | | Dirty bomb |

### Submarine Detection

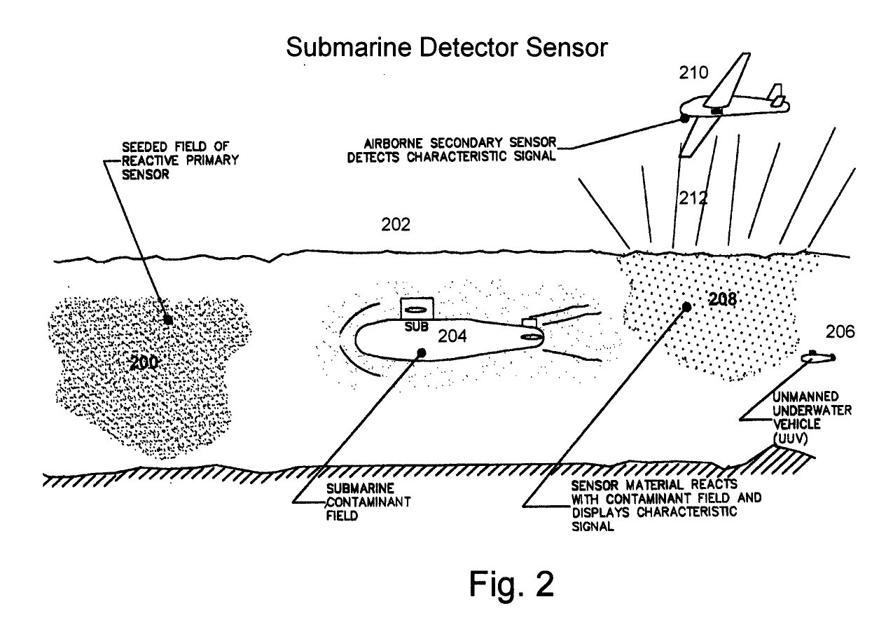

FIG. 2 illustrates a method of submarine 204 detection using the inventive sensors. A multiplicity of sensors 200 are seeded in a volume of water 202. Said water may be sea water. Said sensors may be seeded by an unmanned underwater vehicle 206.

The sensors comprise a core, an intermediate layer and an outer layer. The overall size and density of the sensors is chosen so that the sensors disperse themselves uniformly over a given range of depths in said volume of water. Selected densities in the range of 1.015 to 1.035 g/cc are suitable.

The outer layer of said sensors has a density greater than said water. The combined core and intermediate layer have a density less than the water they are distributed in.

The intermediate layer is designed such that it if said sensor is subject to the shear forces generated by a submarine wake or propulsion system, at least a portion of said outer layer spalls off of said intermediate layer. Said sensor would then float 208 to the surface of said volume of water.

Said intermediate layer is designed to be detectible by an aircraft 210 passing over said volume of water. For example, said intermediate layer may comprise a fluorescent dye. Said aircraft may interrogate said sensors on the surface of said volume of water with a laser and monitor for fluorescent emissions 212. Hence said submarine becomes detectible and trackable by said aircraft.

Table 2 presents a range of thicknesses of said layers that are suitable for submarine tracking. Column 1 identifies the layer. Column 2 shows the range of suitable thicknesses. Column 3 shows the activity of the layer.

TABLE 2
Sensor Layers for Submarine Detection and Tracking

| Layer | Thickness | Activity/Function |
|---|---|---|
| Overall sensor | 10 nm-5,000 μm | Detect and track |
| | | submarine |
| Outer layer | 1 nm-3,000 μm | Sheds when subjected to |
| | | shear forces |
| Intermediate layer | 1 nm-3,000 μm | Luminant or dye layer |
| Core | 1 nm-3,000 μm | Substrate |

A suitable overall diameter for said sensors is in the range of 10 nm (i.e. 5 nanometer) to 5,000 μm (i.e. micron or micrometer). A preferred range is 0.5 μm to 3,000 μm.

Suitable thicknesses for the outer layer are in the range of 1 nm to 3,000 μm.

Suitable materials for the outer layer include biodegradable polylactic acid, and aliphatic polyesters or vinyls or olefinics or such polymers with reactive carboxyl, hydroxyl, or other water insensitive groups.

Suitable thicknesses for the intermediate layer are in the range of 1 nm to 3,000 μm.

Suitable materials for the intermediate layer include functional olefin homo- or copolymer, SEBS block copolymer (with functionality such as acrylic acid, hydroxyl or other equivalents), or low surface free energy polymers such as fluorinated polymers (e.g., fluoro-olefinics) and polysiloxanes and derivatives.

The intermediate layer may also be physically modified such that it comprises polymer “brushes” to assist in the optimization of interfacial energy.

The materials and physical modifications and dimensions of the intermediate layer, outer layer and interfacial energy therebetween are chosen such that at least a portion of the outer layer will spall off of said intermediate layer when the sensor is exposed to shear forces or wake energy generated by a submarine.

The intermediate layer further comprises luminescent or dye material. Suitable luminescent materials include inorganic and organic luminescent materials. Suitable inorganic luminescent materials include rare earth metal sulfides, such as AVeda™ pigments provided by United Mineral & Chemical Corp (Lyndhurst, N.J.). Suitable organic luminescent materials include Beaver Luminescent Pigments provided by Beaver Luminescers (Newton, Mass.).

IR luminescent dyes may be used when one wishes to detect a submarine while maintaining stealth. An IR laser would be used to interrogate sensors at the surface of said volume of water and an IR detector would be used to detect the luminescent emissions of any sensors that had floated to said surface.

Suitable thicknesses (diameter) for the core are in the range of 1 nm to 3,000 μm.

Suitable materials for the core include polylactic acid, biodegradable polyesters, and polyolefins (e.g., polyethylene, polypropylene).

The core may further comprise additives to reduce its density. Suitable additives include glass bubbles or hollow glass spheres. The glass spheres may have a diameter in the range of 1 to 500 microns. The density of the glass spheres may be in the range of 0.1 to 0.5 μm/cc. Suitable glass spheres include Scotchlite™ glass bubbles available from 3M company (St. Paul, Minn.).

Glass bubbles may also be added to the intermediate layer or outer layer to modify their respective densities.

The lower the density of the core, the faster the sensor will rise when the outer layer spalls off, depending upon the diameter of said sensor.

Density reducing agents may also be added to the intermediate layer.

The sensor may be designed such that at least a portion of both the intermediate layer and the outer layer spall off of the core when the sensor is subjected to shear forces. The luminant or dye material would then be in the core.

The outer layer and the intermediate layer may be a single layer. Similarly, the intermediate layer and the core may be a single layer. In each of these cases, the sensor would be a two-layer sensor.

### EXAMPLE 1

In order to detect a submarine in a given volume of water, 50,000 detector particles are dispersed by an unmanned underwater vehicle over a one square mile area of the coastal zone. The sensors are 2,000 μm in diameter and have an average density of about 1.025 g/cc. The sensors are distributed uniformly over a depth of 1,000 feet from the surface.

The sensors have three layers.

The outer layer of the sensors is poly(lactic acid) with a thickness of 500 nm.

The intermediate layer of the sensors is polyethylene containing silicone slip additives and a conventional fluorescent dye.

The core is polyester of such diameter and density that the particle is initially neutrally buoyant at a given depth. Core polymer density is adjusted to a desired value by compounding the core polymer with glass beads.

When a submarine passes thru the particle field, the submarine propeller wake energy causes the outer layer to be shed exposing the intermediate layer containing the ruminant. The sensor then floats to the surface where it is detected by an airplane using a conventional UV or IR detector.

### EXAMPLE 2

100,000 sensors are dispersed by a helicopter over a two square mile area of the ocean down to a 1000 feet depth using a particle depth sowing device. The sensors are 1,000 μm in diameter and are distributed uniformly over the entire depth of 1,000 feet.

The outer layer of the sensors is polystyrene with a thickness suitable to give a particle its desired density.

The intermediate layer is polyethylene containing a wax additive. The thickness of the intermediate layer is 100 nm. The intermediate layer is designed such that both the intermediate layer and outer layer will shed when the sensor is subjected to the wake energy of a submarine.

The core is polyester mixed with a conventional fluorescent dye and sufficient glass beads to achieve proper density for initial neutral buoyancy at a given depth and positive buoyancy after shedding the intermediate layer and outer layer.

When a submarine passes through the sensor field, the intermediate layer is released from the core by the energetic action of the submarine wake. The core polyester particle then floats to the surface where it is detected by a drone using a conventional detector.

The sensors can be dispersed by aircraft, surface vessel, drone, or underwater vehicle. The sensors can be detected by standard external monitors in aircraft, drone, surface vessels, or under water vehicles. Additionally, the sensors should be of good physical integrity so that they can withstand the shear forces of distribution.

The size and density of the sensors may be selected so that they remain suspended over a range of depths for a suitable period of time, given the local currents. Persistence times of ½ hour to 48 hours are suitable for submarine tracking.

### Swimmer Detection

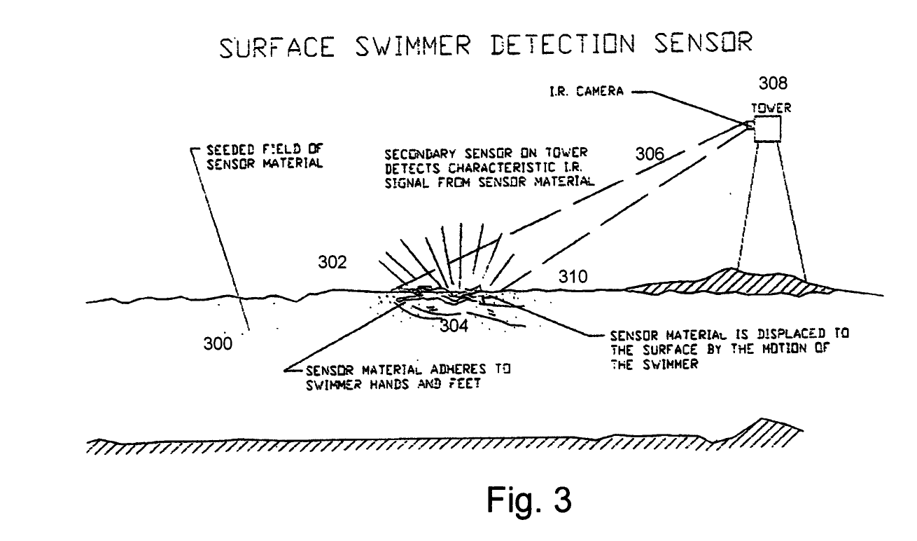

FIG. 3 illustrates a method of swimmer detection using the inventive sensors. Similar methods can be used to detect surface water craft.

A multiplicity of sensors 300 are seeded in a volume of water 302. The sensors are deployed just below the surface of the water. The sensors may comprise three layers.

Table 3 presents a range of thicknesses of said layers that are suitable for swimmer tracking. Column 1 identifies the layer. Column 2 shows the range of suitable thicknesses. Column 3 shows the activity of the layer.

TABLE 3
Sensor Layers for Swimmer Detection and Tracking

| Layer | Thickness | Activity/Function |
|---|---|---|
| Overall sensor | 10 nm-5,000 μm | Detection of swimmer |
| | | Increased acoustic range |
| Outer layer | 1 nm-3,000 μm | Clear adhesive layer |
| Intermediate layer | 1 nm-3,000 μm | Luminant or acoustic |
| | | reflective layer |
| Core | 1 nm-3,000 μm | Substrate |

A sensor may have a spherical shape with a diameter in the range of 100 nm to 10,000 μm.

A sensor may be flat shape. Said flat shape may be a square or rectangle with edge lengths in the range of 1 micron to 10 cm. The total thickness may be 15,000 μm or less.

A flat sensor may have a woven core structure.

A sensor comprises an outer layer. A suitable thickness of said outer layer is in the range of 100 nm to 2,500 μm.

Said outer layer may comprise an IR transparent adhesive. Said adhesive may comprise an epoxy, cyanoacrylate, phenolic or other water stable adhesive.

A sensor may comprise an intermediate layer. A suitable thickness for said intermediate layer is in the range of 100 nm to 5,000 μm.

Said intermediate layer may preferably comprise an IR fluorescent dye. Said intermediate layer may alternatively comprise UV fluorescent dyes.

Said outer layer adhesive should be thin enough and transparent enough at suitable frequencies of light so that said sensors will have detectible fluorescence when interrogated by a laser.

The sensor further comprises a core. The core is designed such that the sensors are neutrally buoyant with respect to water over a suitable range of depth.

A swimmer 304 that comes in contact with said sensors will have said sensors adhere to him/her.

The surface 310 of the water 302 may be interrogated by an IR laser 306 from an observation tower 308 or other suitable vantage point. When a sensor adheres to said swimmer, the IR fluorescence from the sensor is visible from said observation tower.

Said IR fluorescence may be observed using known means, such as SeaFLIR M® (available from FLIR Systems, Inc., Portland Oreg.), Cohu 2700™ (available from Cohu, Inc., San Diego, Calif.), Sony Block Camera™ (available from Erdman Video Systems, Miami, Fla.) or other suitable IR detection device.

Identification can be enhanced by analyzing said fluorescent signal to determine if there is motion characteristic of a swimmer. Said motion can be a periodicity in said signal. Said periodicity may have a characteristic frequency of kicking or arm motion.

### EXAMPLE 3

It is a foggy night. A surface swimmer enters the port area of a submarine base. He comes in contact with neutrally buoyant adhesive coated sensors deployed ½ to 3 feet below the water surface. The sensors adhere to his body, hands, and feet. He does not notice this at first and continues swimming.

The sensors are spherical core/shell polymeric material about 4 mm in diameter with a clear transparent phenolic adhesive outer layer.

The intermediate layer comprises an IR luminescent spiked polyvinyl alcohol polymer.

The core is a biodegradable polymer.

The illuminating rays of an IR laser cycle over the port water area. Said rays are incident on the swimmer's hands and feet which intermittently break though the water's surface.

On illumination, the luminescent sensors sticking to the swimming intruder emit an IR signal which—even though it is a foggy night-are sensed by a Cohu 2700 camera located in a surveillance tower. The tower relays the information to a control area and sets off an alarm for security action.

### EXAMPLE 4

It is a clear night. A surface swimmer in a wet suit enters the water adjacent to a nuclear power plant. He has a propulsion device.

His hands, body, and propulsion device come in contact with adhesive, neutrally buoyant sensors deployed from ½ to 3 feet below the surface. Each sensor is a dual coated nylon fabric about ½ inch square.

Each sensor comprises an outer layer. Said outer layer comprises a thin (˜500 μm) clear transparent acrylic adhesive material. The adhesive sensors stick to the swimmer and said propulsion device.

Each sensor comprises an intermediate layer. Said intermediate layer is an IR activated luminescent spiked polyethylene polymer.

Illuminating rays of an IR lamp on a tower which covers the water area near said nuclear power plant are incident on said swimmer. As a result, said sensors emit an IR signal which is sensed by a sensitive IR camera located in a patrolling surface craft. Said patrolling surface craft then signals a security team who interdict said swimmer.

### EXAMPLE 5

There is a morning fog. An underwater swimmer surfaces near a chemical plant. He comes in contact with sensors which are deployed in the water ½ to 4 feet below the surface. The sensors are adhesive and neutrally buoyant. They adhere to said swimmer's hands and feet which periodically break out from the surface in a swimmer's motion.

Said sensors are 5/8 inch wide by ¼ inch long coated polyester fabric.

Said sensors comprise an outer layer. Said outer layer comprises clear transparent cyanoacrylate adhesive.

Said sensors further comprise an intermediate layer. Said intermediate layer comprises a biodegradable polymer with dispersed IR pigment.

Illuminating rays from an IR lamp periodically flood said port area from a security tower. As a result the sensors adhering to said swimmer are periodically activated and emit an IR signal which is sensed by a Sony Block Camera in said tower.

A computerized signal algorithm confirms the presence of said swimmer via the characteristic motions of said IR emissions from his hands and feet as he moves through the water.

Security is called to the scene.

### EXAMPLE 6

An underwater swimmer approaches a protected asset in a port area or in open water and senses an acoustic energy field in his/her area of the water. The swimmer simultaneously passes through a seeded field of first sensors which adhere to him.

Said first sensors comprise an outer adhesive layer.

Said first sensors further comprise an intermediate layer. Said intermediate layer comprises metal or other acoustically reflective material.

An acoustic sensor detects the characteristic swimmer's motion of said first sensors thus indicating the presence of said swimmer.

The acoustic signal is extremely loud such that as said swimmer gets closer to its source, said swimmer experiences discomfort.

The swimmer quickly maneuvers to try to avoid both being detected and the acoustic discomfort and quickly comes up to the surface to escape the impinging acoustic energy.

However, there are second sensors deployed just below the surface which also adhere to said swimmer's hands and feet.

Said second sensors comprise an outer layer. Said outer layer is adhesive.

Said second sensors further comprise an intermediate layer. Said intermediate layer comprises a fluorescent dye.

The adhered second sensors emit a characteristic optical signal when interrogated by a laser beam from a surveillance boat. Said optical signal is detected by a sensor on said boat indicating that a swimmer has come to the surface.

Security people quickly engage the swimming intruder.

### Missile Detection

Sensors of the present invention may be used in airborne applications. Sensors may be made neutrally buoyant with respect to air at a given altitude and temperature by incorporating gases lighter than air, such as helium, in their structure.

Sensors may be used to detect ballistic missile launches. Sensor particles are dispersed in a cloud above the coastline near an adversary's ballistic missile site. The sensors will detect the missile launch in real time and relay the information to a command post. The sensors are triggered by a missile's wake.

The sensors may comprise three layers.

Table 4 presents a range of thicknesses of said layers that are suitable for missile tracking. Column 1 identifies the layer. Column 2 shows the range of suitable thicknesses. Column 3 shows the activity of the layer.

TABLE 4
Sensor Layers for Missile Detection and Tracking

| Layer | Thickness | Activity/Function |
|---|---|---|
| Overall sensor | 3 nm-1,000 μm | Detection and tracking of |
| | | missile |
| Outer layer | 1 nm-1,000 μm | Protective layer |
| Intermediate layer | 1 nm-1,000 μm | Luminant or dye layer |
| Core | 1 nm-2,000 μm | Substrate |

Suitable thicknesses for outer layers are in the range of 1 nm to 1,000 μm.

Suitable outer layer materials include high performance materials such as polyphenylene sulfides (PPS), polybenzimidazoles (PBI), polyimide (PI) or foams.

Suitable thicknesses for intermediate layers are in the range of 1 nm to 1,000 μm.

Suitable intermediate layer materials include engineering resin or foam such as polyamide, and low surface free energy polymers such as fluorinated polymers or polysiloxane derivatives.

The intermediate layer further comprises luminescent or colored dye material.

Suitable thicknesses of the core are in the range of 1 nm to 3,000 μm.

Suitable core materials include polymers such as PPS, PBI, PI and foams in a diameter range of 1 nm to 2,000 μm. The core material may be biodegradable.

The core may be hollow and filled with helium such that the overall density of the sensor is about the same as air at a desired altitude.

The outer layer is released by missile wake energy revealing a color or luminescence of the intermediate layer.

The outer layer and intermediate layer may be designed such that specific wake features, such as wake temperature, energy, or missile climb rate cause the outer layer to spall.

The different luminescent materials or different dyes can be incorporated into the intermediate layers of different sensors such that they indicate different events. For example, one color may be used for sensors seeded at a first altitude and another color can be used for different sensors seeded at a second altitude. Thus the colors revealed indicate the altitude of a missile. The time delay between the appearance of said first color and said second color can indicate the climb rate of said missile.

Similarly, different colors may be used for different sensors with different interfacial energies thus indicating different levels of energy in a missile wake.

The total quantity of sensors deployed at a given time is at least in the range of 100 to 10,000 or greater.

The sensors can be dispersed by helicopter, airplane, satellite, or drone. The sensors may be deployed by releasing a capsule which provides a mechanical spray of said sensors.

The sensors can be detected by standard external monitors in airplanes, drones helicopters, or satellites.

The sensors should be of good physical integrity.

The sensors should have a density in the range of zero to 0.0807 lb/cu. foot (density of air at 32 F, 1 atm.) in carefully selected increments so as to arrange themselves along a suitable air column through the coverage air space.

The time of seeding will be correlated with an anticipated launch time of said missile and weather conditions.

### EXAMPLE 7

10,000 detector particles are dispersed by aircraft over five square miles of airspace on the coast adjacent to a missile launch site. The particles are 500 nm in diameter and have a distribution of density relative to air density such that the particles distribute themselves uniformly over a height from ground level to 1,000 feet in the air. The outer layer of the particles is high performance polyimide polymer foam with a thickness suitable to give a bead particle its respective desired density. The intermediate layer is a high heat polyamide foam derivative and contains red dye material. The thickness of the intermediate layer is 800 nm. The core is poly(phenylene sulfide) foam. All foams are closed cell foams filled with helium.

When a ballistic missile is fired and flies in/or near the particle air space, the wake energy breaks the weak bonds between the slip modified intermediate layer and the outer layer. The outer layer is therefore shed.

A red dye of the intermediate layer is then detected by an aircraft using a conventional visible spectrum detector.

### Wind Shear

Airborne sensors with three layers can be designed to track an unstable and unsafe wind shear in an airport take-off or landing zone and relay the information to a control tower.

The sensors may comprise three layers. A one layer “core only” sensor may also be suitable.

Table 5 presents a range of thicknesses of said layers that are suitable for wind shear detection. Column 1 identifies the layer. Column 2 shows the range of suitable thicknesses. Column 3 shows the activity of the layer.

TABLE 5
Sensor Layers for Wind Shear Detection and Tracking

| Layer | Thickness | Activity/Function |
|---|---|---|
| Overall sensor | 3 nm-1,000 μm | Wind direction and |
| | | intensity |
| Outer layer | 1 nm-1,000 μm | Protective layer |
| Intermediate layer | 1 nm-2,000 μm | Released by wind shear |
| Core | 3 nm-1,000 μm | Luminesces in color |
| | | indicative of wind shear |
| | | level |
| Core only sensor | 3 nm-1,000 μm | Wind shear intensity and |
| | | direction |

A suitable thickness for the outer layer of said sensors is in the range of 1 nm to 1,000 μm.

Said outer layer may comprise polylactic acid, biodegradable polyesters, polyolefins (polyethylene, polypropylene) and foams of these polymers in a coating thickness range of 1 nm to 1,000 μm.

A suitable thickness for an intermediate layer is in the range of 1 nm to 1,000 μm.

Suitable materials for said intermediate layer comprise polyolefins (polyethylene, polypropylene homo- or copolymer), or other low surface free energy polymers such as polyacetal, or silicone or fluorinated polymers. Said materials can be foamed.

Suitable core thicknesses are in the range of 1 nm to 2,000 μm.

Suitable core materials include polymers modified/coated: to be luminescent, or colored via dye material where the base polymer can be polylactic acid, biodegradable polyesters, polyolefins (polyethylene, polypropylene) and foams of these polymers.

The sensors contain a gas lighter than air such that they are neutrally buoyant with respect to air at a given altitude. A mixture of sensors with a range of densities is deployed such that sensors distribute themselves over a range of altitudes.

If a sensor experiences wind shear above a certain level, the intermediate layer releases from the core by the action of the wind shear thus exhibiting luminescence or color.

The core color can be tuned to specific levels of disturbance-such as wind activity or energy. This is accomplished by designing bead fractions with different levels of interfacial energy corresponding to different levels of wind energy.

The total quantity of sensors can be in the range of 100 to 10,000 or more, depending upon the application.

The sensors can be dispersed by helicopter, airplane, drone, or mechanical spray. The rate of dispersal and configuration should take into account the general wind activity and it's profile so as to obtain an effective configuration.

The sensors can be detected by photomultiplier, or other suitable electronic or photonic device in a helicopter, airplane, drone, or in a ground facility such as in an airport tower.

Lasers are frequently used to activate luminescent materials which respond at a different wave length (e.g., incident 830 nm laser, response 950 nm).

Additionally, the sensors should be of good physical integrity and generally in a density range of from zero to 0.0807 lb/cu. foot (density of air at 32 F, 1 atm.) in carefully selected increments so as to arrange themselves along a suitable air column through the coverage air space. This can be accomplished by a sensor bead with a helium filled hollow core, or helium in a closed cell foam as part of the bead structure.

Wind, bead/air interfacial frictional features and buoyancy features also contribute to the aerosol stability.

The bead structure, size and density are selected taking into account wind effect such that the sensors persist in a general selected configuration for about %2 hour to 1 hour.

### EXAMPLE 8

10,000 sensors are dispersed by helicopter over a one square mile of airspace above a take-off zone at the end of the runway. The sensors are 1 micron in diameter and have a distribution of density such that they distribute themselves uniformly over a height from ground level to 1,000 feet above the takeoff area.

The outer layer of said sensors is polyester foam with a thickness suitable to give a particle its desired density.

The intermediate layer of said sensors is polypropylene with silicone additive. The thickness of the intermediate layer is 500 nm.

The core of said sensors is poly(lactic acid) foam.

A first set of said sensors has a green dye material mixed with their cores. Said sensors will spall their intermediate layers and outer layers at a relatively low level of wind shear.

A second set of said sensors has a red dye mixed with their cores. Said second set of sensors will spall their outer layers at a relatively high level of wind energy.

When wind passes through the particle field, the tie layers of the first or second set of sensors may be shed. The core particles then begin to slowly rise and the detector in the tower may detect a green color or a red and green color. Said green color indicates that wind shear levels are elevated. Said red color indicates that wind shear levels are too high to permit safe landing.

If the tower detects red color above a certain threshold, then all aircraft in the area are directed to refrain from using said air space until an “all clear” is given.

In an alternative embodiment, said intermediate layer comprises said dye material and only said outer layer is shed.

In another alternative embodiment, said core contains a luminescent material which is activated by a laser at the airport tower or other suitable place. There is no intermediate layer or outer layer coating said core. This is a one-layer polymer system. The general movement of the particles is indicative of the wind shear intensity and direction. This method is much more sensitive that existing systems which utilize only scattering from the motion of air molecules which are very small yielding very weak scattering signals.

### Bafflefield

Airborne sensors of the present invention may be used in a battlefield. Said sensors may be designed to detect chemical or biological warfare agents. Said agents may comprise Sarin or VX nerve gases.

Said sensors may also comprise materials to neutralize said chemical or biological warfare agents.

Said sensors may be incorporated into clothing, vehicle or housing structures.

Said sensors can be projected a distance in a mortar or a howitzer or other gun or released from a drone or helicopter to a prospective soldier advance zone.

Said sensors may have a diameter in the range of 5 nm to 5,000 μm and comprise an outer layer, intermediate layer and core.

A suitable outer layer thickness is in the range of 1 nm to 2,000 μm.

Suitable outer layer materials include functional polyolefins (polyethylene, polypropylene homo- and copolymers), polyvinyl chloride or functional biodegradable polymers such as polylactic acid, aliphatic polyesters foams, etc.

Said materials may comprise functional groups. Said functional groups are selected from: anhydride, hydroxyl, siloxy, amine, epoxy, oxazoline, carboxylic acid, isocyanate, carbodiimide, and allyl lactam.

An example of a reactive surface functionality which can neutralize a chemical agent is hydroxyl or siloxy. These functionalities react with sarin.

The intermediate layer may have a thickness in the range of 1 nm to 1,000 μm.

Suitable intermediate layer materials include low surface free energy polymers such as fluorinated or polysiloxane derivatives, polyolefins, vinyls, polyesters, etc. with selected slip additives (e.g., silicones, waxes, or similar acting agents).

The intermediate layers further comprise luminescent or dye materials.

The cores may have a diameter in the range of 1 nm to 2,000 μm.

Suitable core materials include polylactic acid, biodegradable polyesters, polyolefins, and polyvinyls.

Helium may be incorporated into said sensors for airborne deployment.

When a sensor is exposed to a chemical or biological warfare agent to which it is sensitive, the outer layer separates from the intermediate layer. The separation occurs via a significant reduction in bond strength between the outer layer and intermediate layer promoted, for example, by: additives, such as silicones, waxes, or other slip agents; reaction by-product formation, change in pH, or change in dimensions of the outer layer with respect to the intermediate layer. Additives to the outer layer or the intermediate layer adjust the release free energy to the desired extent for the particular interface. Additives may also be added to adjust the relative coefficient of linear expansion of said layers.

When an outer layer separates at least in part from an intermediate layer, the fluorescent material or dye becomes visible thus indicating the presence of a particular chemical or biological warfare agent.

Alternatively, the color change and detection results on coating/contaminant reaction in a designed dual coating layer wherein the top layer is very thin (1 nm-300 μm) and on reaction with chemical or biological agent reveals to view or detector the thicker color containing polymer which contains the color (typically dye or ruminant). The color is so chosen to indicate a particular chemical or biological warfare agent via fractions of sensors so designed. The total quantity of sensors is at least in the range of 100 to 10,000 or more.

Generally, the sensors can be dispersed on clothing or a structure wall by mechanical spray, coating, or brush with or without a polymeric binder on the substrate. The sensors can be detected by standard external monitors in a vehicle, hand held device, drones, or helicopters.

The sensors themselves should be of good coatability (via brush or spray or equivalent), and good surface adhesion to the selected clothing fabric or structural material, as well as good weatherability and physical integrity.

### EXAMPLE 9

10,000 sensors are projected 10 miles via howitzer into a prospective soldier advance zone. The sensors are in a capsule which sprays the sensors in a desired location.

The sensors are 1,000 μm in diameter. They have a distribution of density from zero to 0.0807 lb/cu. foot (density of air at 32 F, 1 atm.) such that they distribute themselves uniformly over a height from ground level to 1,000 feet above the zone. The sensors employ a helium filled hollow core.

The outer layer of the sensors is polyethylene foam functionalized with hydroxyl groups to react with sarin. The outer layer has a thickness of about 5 nm suitable to give said sensor its desired density.

Said outer layer comprises a hydroxyl functionality such that the core below said outer layer becomes visible upon exposure of said outer layer to sarin.

There is no intermediate layer.

The core is biodegradable polyester mixed with a conventional fluorescent green dye. The core is hollow and helium filled.

When agent sarin comes in contact with said sensors, the hydroxyl functionality in the outer layer reacts with said sarin and the surface layer is removed. A green colored core is then visible, and is detected by a drone overhead. The information is then relayed back to a base area.

Other sensors are present with functionality to react with vx. They have a blue colored core. Said blue cores are not visible hence vx is not present.

### Shipping Container

Sensors suitable for detecting chemical or biological agents or so called dirty bombs may be used in homeland security applications, such as in ship container security.

The sensors may comprise three layers.

Table 6 presents a range of thicknesses of said layers that are suitable for detecting chemical or biological agents in a shipping container. Column 1 identifies the layer. Column 2 shows the range of suitable thicknesses. Column 3 shows the activity of the layer.

TABLE 6
Sensor Layers for Chemical or Biological
Agents in Shipping Applications

| Layer | Thickness | Activity/Function |
|---|---|---|
| Overall sensor | 5 nm-5,000 μm | Chemical or biological |
| | | agent or dirty bomb |
| | | detection. |
| Outer layer | 1 nm-3,000 μm | Reactive layer |
| Intermediate layer | 1 nm-1,000 μm | Luminant or dye layer |
| Core | 3 nm-2,000 μm | Substrate |

Said sensors may be incorporated onto a polymeric film surface. Said film surface may be visible through a window portal and/or be connected to an external computer system.

Said sensors may undergo a color change specific to a particular chemical or biological warfare agent (e.g., sarin, VX).

Said sensors may undergo a conductivity change on sensing a dirty bomb or another radioactive source.

A suitable diameter for said sensors is in the range of 5 nm to 5,000 μm.

Said sensors may comprise an outer layer, intermediate layer and core.

The outer layer of said sensors may have a thickness in the range of 1 nm to 3,000 μm.

Suitable materials for said outer layer include functional polymers such as functional polyolefins (polyethylene, polypropylene) including homo- and copolymers, poly(vinyl chloride), or biodegradable materials including functional polylactic acid, and aliphatic polyesters.

Suitable outer layer surface functionality is so chosen as to be reactive to a particular chemical or biological warfare agent. The reactive functionality can include one or more of the following: anhydride, acid, hydroxyl, siloxy, amine, epoxy, oxazoline, allyl lactam, or carbodiimide depending on the agent. For example, hydroxyl or siloxy would be suitable for reacting with the chemical agent sarin.

The intermediate layer may have a thickness of 1 nm to 1,000 μm.

Suitable intermediate layer materials can be selected from the polymer alternatives cited for the outer layer. They are different from the polymer selected for the outer layer.

A suitable dye or luminescent material is mixed with the intermediate layer.

The core can be polyolefin homo- or copolymers, polyvinyl chloride, aliphatic polyester or similar polymers.

On reaction of the outer layer with the chemical or biological warfare agent, said outer layer releases from the intermediate layer. The luminescence or color of the intermediate layer is then visible. The release occurs via a significant reduction in the bond strength of the intermediate layer/outer layer interface. Said reduction of bond strength may be promoted for example by: reaction by-product formation, change in pH, or change in dimensions of the outer layer with respect to the intermediate layer. The level of releasability may be tailored with additives such as silicone, wax, etc. Additives may also be added to adjust the relative coefficient of linear expansion of the different layers.

A two-layer sensor may be suitable for this application. Said two layer system comprises an outer layer and a core. Said outer layer is very thin. The thickness of said outer layer is in the range of 1 nm to 300 microns. Reaction of the thin outer layer with a particular chemical or biological agent results in at least the partial removal of said outer layer. The core, which is made of a suitably different polymer than the outer layer, is revealed. The core comprises color or fluorescent dye and is hence visible thus indicating the presence of said given chemical or biological agent.

A given set of sensors may comprise a mixture of sensors. Said mixture of sensors comprises different sensors that reveal different colors upon exposure to different chemical or biological agents.

The color is specific to a particular chemical or biological agent. This is achieved by fractions of sensors designed with different reactive chemistry and colors for particular chemical or biological agents.

Suitable core diameters are in the range of 1 nm to 2,000 μm.

Suitable core materials for said sensors include polyethylene, polypropylene homo- and copolymers, or biodegradable materials such as polylactic acid polymers.

The total quantity of sensors is in the range 100 to 10,000 or more.

In a manufacturing process for ship container sensors, the sensors are coated on a polymer film from a dispersion of said sensors in a dilute adhesive solution in a volatile solvent. Said coating is slowly dried thus evaporating said solvent and leaving said sensors adhered to said polymer film by said clear adhesive.

The gauge of the base film can be in the range of 1.0 mil to 20 mil. The base film is clear and of good physical integrity.

The base film can be made of one of the following: polypropylene, polystyrene, polyester (e.g., Mylar), flexible vinyl, or other similar clear film.

Said sensor adhesive coating system must be of good permeability to the chemical or biological agent to be detected.

### EXAMPLE 10

10,000 of sensors are dispersed into an adhesive film and coated onto a polymer base film as described above to form a film composite. Said base film is 5 mils thick. Said adhesive film containing said sensors is 0.1 mil thick.

Said film composite is placed on the inner wall of a ship container via an adhesive backing.

Said film composite can be seen from outside said container through a port in the container door adjacent to the seal such that a color reading can be observed.

Said sensors are 1,000 μm in diameter and are distributed uniformly over the surface of said base film.

Said sensors comprise an outer layer which is 0.1 mil thick.

The functionality (e.g. hydroxyl, siloxy or anhydride) if said outer layer of said sensors is chosen to be reactive to the vapor of sarin, an organophosphorous compound.

The intermediate layer of said sensors is polyester mixed with a conventional red dye. Said dye can be detected by a typical visible spectrum detector or by visual means through the container window.

While particular embodiments of the present invention have been illustrated and described, it would be obvious to those skilled in the art that various other changes and modifications can be made without departing from the spirit and scope of the invention. Any of the aspects of the present invention found to offer advantages over the state of the art may be used separately or in any suitable combination to achieve some or all of the benefits of the invention disclosed herein.

1. A sensor for detecting a triggering stimulus, said sensor comprising:
a) an outer layer;
b) an intermediate layer; and
c) a core;
wherein said triggering stimulus causes a change in a detectable property of said sensor such that said change in said detectable property is detectible by an external monitor.

2. The sensor of claim 1 wherein said surface layer comprises a water resistant polymer.

3. The sensor of claim 2 wherein said water resistant polymer comprises one or more of a polyolefin, polyvinyl, styrenic, or vinyl.

4. The sensor of claim 1 wherein said outer layer has a thickness in the range of 1 nanometer to 5,000 μm;

5. The sensor of claim 1 wherein said intermediate layer comprises a low surface energy polymer.

6. The sensor of claim 5 wherein said low surface energy polymer comprises one or more of a polyethylene or a polysiloxane.

7. The sensor of claim 5 wherein said intermediate layer further comprises silicones or waxes

8. The sensor of claim 1 wherein said intermediate layer has a thickness in the range of 1 nanometer to 3,000 μm.

9. The sensor of claim 1 wherein said sensor has a spherical shape, said core comprises one or more of a biodegradable polymer, commodity polymer, specialty polymer or engineering polymer, a ruminant or a dye; and wherein said core has a spherical shape with a diameter in the range of 1 nanometer to 5,000 μm.

10. The sensor of claim 1 wherein the interface between said intermediate layer and said core is such that at least a portion of said intermediate layer separates from said core when said sensor is exposed to the wake energy of a submarine.

11. The sensor of claim 10 wherein said core comprises a luminescent or a dye material.

12. The sensor of claim 1 wherein said sensor is has a spherical shape and wherein the density of said sensor is about that of either sea water or fresh water such that said sensor is neutrally buoyant at a depth of either sea water or fresh water, said depth being in the range of 0 to 1000 feet.

13. The sensor of claim 12 wherein the core of said sensor has a density less than that of either sea water or fresh water such that said sensor will float to the surface of sea water or fresh water if at least a portion of said surface layer is removed.

14. The sensor of claim 13 wherein said core comprises a luminescent material such that said sensor is visible to a luminescence sensor mounted on an air craft when at least a portion of said outer layer and said intermediate layer is removed from said core and said core is floating at or near the surface of either sea water or fresh water.

15. The sensor of claim 1 wherein
a) said sensor has a spherical shape;
b) the interface between said outer layer and said intermediate layer is such that said outer layer separates from said intermediate layer when said sensor is exposed to the wake of a submarine;
c) said intermediate layer comprises a ruminant such that said ruminant is detectible from a sensor on a plane when said outer layer is removed from said sensor and said sensor is at the surface of sea water;
d) the density of said sensor is about the same as that of sea water;
e) the density of the combination of said intermediate layer and said core is less than that of sea water such that said combination will float to the surface of sea water when said outer layer is removed from said sensor.

16. A method for detecting a swimmer in a first volume of water, said method comprising the steps of:
a) dispersing a plurality of first sensors in said first volume of water, said first sensors designed to:
i. adhere to a swimmer passing through said first volume of water; and
ii. reflect acoustical energy,
b) broadcasting acoustic energy in said first volume of water, said acoustic energy having sufficient strength to cause at least discomfort in a swimmer;
c) monitoring said first volume of water with an acoustic detector to detect acoustic energy reflected off said first sensors;
d) analyzing the detected acoustic energy reflected off of said first sensors to identify the characteristic motion of a swimmer; and
e) triggering a first alarm if said analysis identifies the characteristic motion of a swimmer.

17. The method of claim 16 which further comprises the steps of:
a) dispersing a plurality of second sensors in a second volume of water, said second sensors designed to:
i. adhere to a swimmer passing through said second volume of water; and
ii. fluoresce when interrogated by a laser,
b) broadcasting acoustic energy in said first volume of water, said acoustic energy having sufficient strength to cause a swimmer to move from said first volume of water to said second volume of water;
c) monitoring the surface of said second volume of water with a laser and luminescence detector to detect luminescent emissions from said second sensors;
d) analyzing said luminescent emissions to identify the characteristic motion of a swimmer; and
e) triggering a second alarm if said analysis of said luminescent emissions identifies the characteristic motion of a swimmer.

18. The method of claim 17 wherein said second sensors are distributed from between ½ and 3 feet below the surface of said water.

19. A method to detect wind shear at an airport, said method comprising the steps of:
a) dispersing a plurality of sensors in a volume of air adjacent or above said airport, said sensors having a spherical shape and designed to emit a ruminant signal when first exposed to wind shear above a wind shear threshold value and then subsequently interrogated by a laser;
b) interrogating said volume of air with a laser; and
c) triggering an alarm if a luminant signal generated by said interrogation is above a ruminant signal threshold value.

20. The method of claim 19 wherein said sensors have a density about that of air such that said sensors move in concert with wind activity.

21. The method of claim 20 wherein said sensors comprise commodity, specialty or biodegradable polymers and wherein the core of said sensors is hollow and filled at least in part with helium.

22. The method of claim 21 wherein said sensors have a diameter in the range of 1 nm to 5,000 μm such that they will persist in an aerosol for at least four hours.

23. The method of claim 19 wherein said sensors comprise an outer layer, an intermediate layer and a core, said intermediate layer comprises a ruminant material and said interface between said intermediate layer and said outer layer is such that at least a portion of said outer layer will be removed from a given one of said sensors if said given one of said sensors is exposed to wind shear above said wind shear threshold value.

24. The method of claim 23 wherein said sensors comprise a plurality of first sensors and a plurality of second sensors wherein said first sensors have a first wind shear threshold value and the intermediate layers of said first sensors comprise a first luminant material and said second sensors have a second wind shear threshold value and the intermediate layers of said second sensors comprise a second luminant material such that said sensors will indicate that the wind shear is above said first wind shear threshold value if said first ruminant is visible and wherein said sensors will indicate that wind shear is above said second wind shear threshold value if said second ruminant is visible.

25. The method of claim 19 wherein said sensors comprise an outer layer, and a core, said core comprises a ruminant material and said interface between said core and said outer layer is such that at least a portion of said outer layer will be removed from a given one of said sensors if said given one of said sensors is exposed to wind shear above said wind shear threshold value.

26. The method of claim 19 wherein said sensors comprise a core and wherein said core comprises a ruminant material, at least a portion of said ruminant material is visible and said ruminant signal and said ruminant signal threshold value is determined by the measured motion of said sensors.

27. A method of detecting chemical, or biological warfare agents or dirty bombs in a shipping container, said method comprising the steps of:
a) dispersing sensors on to a base film to form a coated film; and
b) adhering said coated film on to the walls of said shipping container, said sensors designed to react with at least one of said chemical or biological warfare agents or said dirty bomb such that said reaction can be detected from outside of said container.

28. The method of claim 27 wherein said sensors are made at least in part from a commodity, specialty or biodegradable polymer.

29. The method of claim 28 wherein said sensors are spherical and have a diameter in the range of 1 nm to 5,000 μm.

30. The method of claim 29 wherein said sensors emit an optical signal upon reaction with said at least one of said chemical or biological warfare agents.

31. The method of claim 30 wherein said sensors comprise a core and an outer layer.

32. The method of claim 31 wherein said sensors comprise an intermediate layer between said core and said outer layer.

33. The method of claim 31 wherein said core comprises a ruminant material and said outer layer comprises a polymer that is reactive with said at least one of said chemical or biological warfare agents such that at least a portion of said outer layer is removed from said core when exposed to said at least one of said chemical or biological warfare agents such that said luminant becomes visible.

34. The method of claim 31 wherein said core comprises a ruminant material and said outer layer comprises a polymer that is reactive with said at least one of said chemical or biological warfare agents such that at least a portion of said outer layer is shed from said core when exposed to said at least one of said chemical or biological warfare agents such that said ruminant becomes visible.

35. The method of claim 34 wherein said shedding is due to at least one of the formation of reaction byproducts, change in ph, or change in dimensions of either of said core or said outer layer.

36. The method of claim 31 wherein said luminant indicates the particular at least one of said chemical or biological warfare agents.

37. The method of claim 27 wherein said sensor undergoes a change in conductivity when exposed to charged particles emitted by a dirty bomb.
